(19) United States
(12) Patent Application Publication
(10) Pub. No.: US 2022/0252870 A1
(43) Pub. Date: Aug. 11, 2022

(54) ACTUATOR FOR AN OPTICAL ELEMENT

(71) Applicant: Hewlett-Packard Development Company, L.P., Spring, TX (US)

(72) Inventors: Haim Livne, Ness Ziona (IL); Nathan Levy, Ness Ziona (IL); Ron Benari, Ness Ziona (IL); Michael Plotkin, Ness Ziona (IL); Craig Breen, Ness Ziona (IL)

(73) Assignee: Hewlett-Packard Development Company, L.P., Spring, TX (US)

(21) Appl. No.: 17/628,584

(22) PCT Filed: Sep. 30, 2019
(86) PCT No.: PCT/US2019/053854

§ 371 Date: Jan. 20, 2022

(51) Int. Cl. G02B 26/12; G03G 15/04; G03G 15/043

(52) U.S. Cl. CPC G02B 26/121; G03G 2215/0404; G03G 15/043; G03G 15/04072

(57) ABSTRACT

An apparatus, for example, the imager of a printer is disclosed. The apparatus comprises an elongate member including an optical element. At least one bearing supports the member to allow rotation about a lengthwise axis of the member. An actuator comprises a plurality of load sharing motors to apply torque to the member at a plurality of locations, the locations being spaced apart along the length of the member.

### BACKGROUND

In digital print presses, printers, photocopiers or scanners an imager may be used to scan a photosensitive surface to form an image thereon. For example, the photosensitive surface may be electrophotographic image plate formed on the outer surface of a drum. The photosensitive surface may subsequently be used to transfer the image to print media. For example, one or more developing units may be provided such that charged toner particles can be deposited or attracted to charged areas of the photosensitive surface creating an image. The toner particles may subsequently be deposited onto print media for example using heat to fuse the toner. The transfer may for example use at least one transfer members such as a roller or belt. The photosensitive surface may be re-charged ready for reuse with a subsequent image (or portion of an image).

In some arrangements a rotatable optical element (for example a mirror or prism) may be provided between the imager and the photosensitive surface. Rotation of such an element may be used for image compensation adjustments for example to correct for inaccuracies in the print or copying apparatus. Such a rotatable optical element may be an elongate member to which small and precise rotational adjustments may be made during use.

### BRIEF DESCRIPTION OF THE DRAWINGS

Various features of the present disclosure will be apparent from the detailed description which follows, taken in conjunction with the accompanying drawings, which together illustrate features of the present disclosure, and wherein:

FIG. 1 is a schematic representation of a print apparatus in accordance with the present disclosure;

FIG. 2 is a schematic showing a motor arrangement in accordance with the disclosure;

FIG. 3A is a schematic top view of a motor component of FIG. 2 in isolation;

FIG. 3B is a three-dimensional schematic view of a motor component of FIG. 2 in isolation;

FIG. 4 is a schematic of a PCB element for use in the motor of the present disclosure.

### DETAILED DESCRIPTION

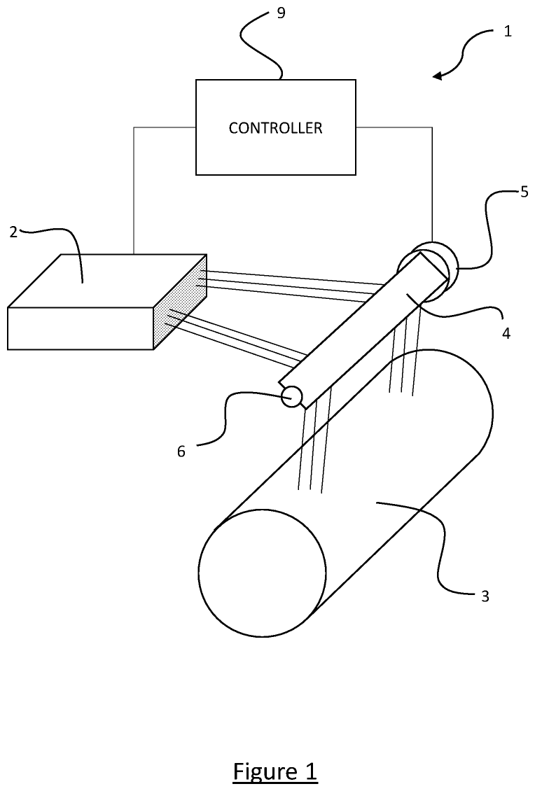

An imager 1 which may be used in a print press in accordance with the present disclosure is shown in FIG. 1. The imager 1 may include a light source 2. The light source 2 may provide at least one scanning beam for use with a photosensitive surface provided on a drum 3. Whilst the present disclosure may be used in a variety of print systems, the system illustrated in FIG. 1 is of the type in which the scanning beam from the light source 2 may be used to expose the surface by selectively applying or removing charge from the photosensitive surface of the drum 3. In other examples the photosensitive surface could be provided on a belt or a plate. The surface of the drum 3 may then pass an associated developing unit 7 where electrically charged print fluid, for example toner or ink, may be transferred onto the charged surface of the drum 3. At least one transfer member, for example roller 8, may be used to transfer the ink from the drum 3 to the print media.

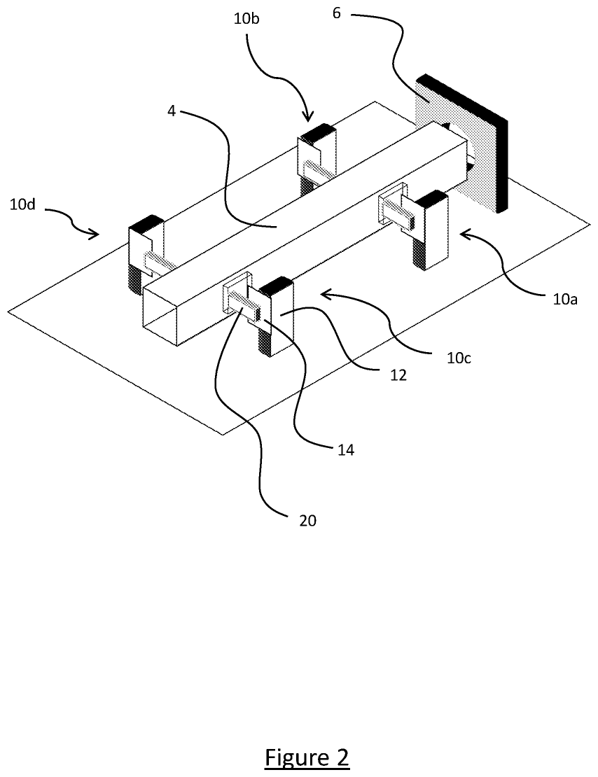

As noted above, to improve image quality a rotatable optical deflector 4, for example a mirror or a prism, may be provided within the beam path between the light source 2 and the photosensitive surface of the drum 3. The controller 9 of the print press may adjust the deflector, for example making micro adjustments throughout the scanning by the light source 2, to apply compensation to the beam (for example to correct due to misalignments or inaccuracies in the print press). To provide controllable rotation of the deflector 4 the deflector may have at least one bearing 6 (to provide rotational support) and an actuator 5 which the controller 9 may use to apply a torque. For clarity the actuator 5 and bearing 6 are shown as simply schematic blocks in FIG. 1 but the relevant arrangements of the present disclosure will be explained in detail below with reference to FIGS. 2 to 4.

For optical reasons it may be desirable to have at least one fully unobstructed surface (for example a mirror surface) to deflect the scanning beam from the light source 2 on at least one side of the deflector 4. As such, the actuator 5 for the deflector 4 may be located at an end of the deflector. Further, the rotatable deflector 4 may extend across substantially the full width of the drum 3. As such, the deflector 4 is generally elongate and may be considered to be a long beam member. The length of the deflector 4 will depend on the maximum media width the print apparatus is intended to be suitable for printing on and may, for example, have a length of around 70 cm. The applicant has recognized that beam twisting may reduce positional accuracy of the deflector 4 along its length.

The present disclosure provides an arrangement in which twisting of the beam of the deflector 4 during rotation may be reduced such that it may be possible to provide greater positional accuracy of the deflector across the full length of the beam. In an imaging application such as a printing press, the adjustments to the deflector 4 may be small, for example a few degrees in one direction or the other but may be made to very high accuracy, for example it may be beneficial to provide an arrangement which can be rotated to several thousand stop points within its range of motion. As such, even small twisting along the length of the deflector 4 can be undesirable.

As shown in FIG. 2 in the present disclosure the deflector 4 may be supported by a bearing 6 provided at one end (and in some implementations at both ends) of the member 4 and can be actuated by a plurality of motors 10a, 10b, 10c and 10d. The motors 10a, 10b, 10c and 10d, may be load sharing. In the present context load sharing may be understood to mean that the motors are commonly controlled (for example by the controller 9) and may act together to apply a torque to the deflector 4. The motors may be distributed along the length of the deflector 4. As the deflector is elongate and rotatable about its length it will be appreciated that references to the length or lengthwise direction of the deflector should be understood to refer to the direction generally parallel to the rotational axis.

For example, the motors may be arranged in a first group, comprising in this example paired motors 10a and 10b, and a second group, comprising in this example paired motors 10c and 10d. The first and second group of motors are each located at different positions along the lengthwise direction of the elongate beam deflector 4 (for example at a first and second axial position relative to the rotational axis). The motors within each pair 10a & 10b and 10c & 10d may be radially opposed relative to the beam. For example, the motors 10a & 10b and 10c & 10d of the pair may be diametrically opposed. The use of paired, opposing, motors may enable an unobstructed surface (for example a mirror surface) to be provided between the motors (in the example of FIG. 2 the upper surface of the deflector 4).

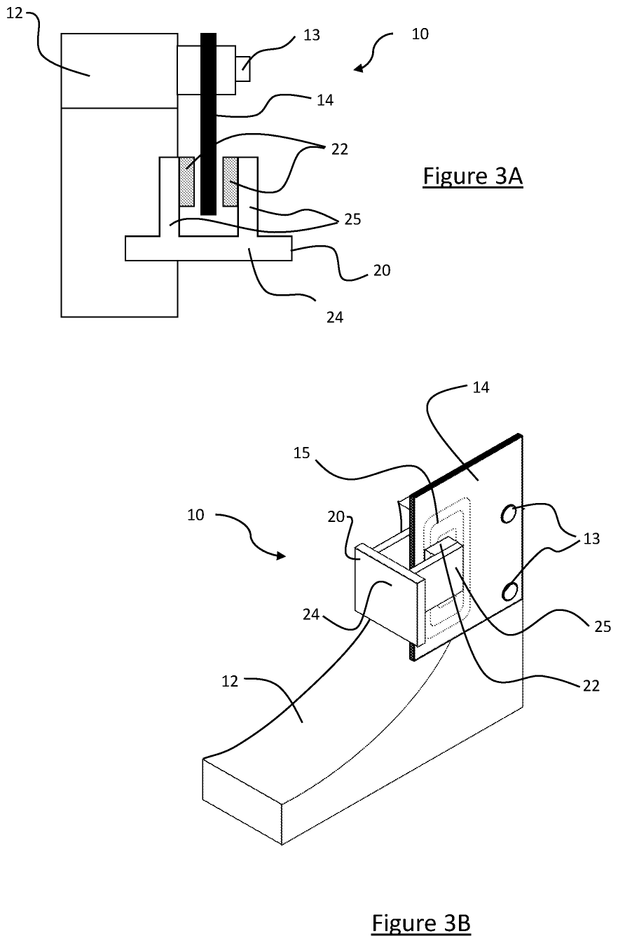

The construction of the motors 10 for use in examples of the present disclosure is shown in further detail in FIGS. 3A and 3B. The motor 10 of the example can be a contactless motor and may use a PCB based construction. Each motor may for example be a linear motor which produces a rotation of the deflector 4 by generating a torque through the application of a force at a location which is radially spaced from the axis of rotation of the deflector 4. The motors 10a & 10b and 10c & 10d within each pair may be controlled to provide opposing forces such that a combined torque may be created at the lengthwise position of the motor pair.

Each motor 10 may comprises a support 12 which is fixed relative to a frame or body of the apparatus. The support may be of any convenient shape and configuration but in the example includes an upstanding portion and a base connected by a curved profile to provide clearance for the rotation of the deflector 4.

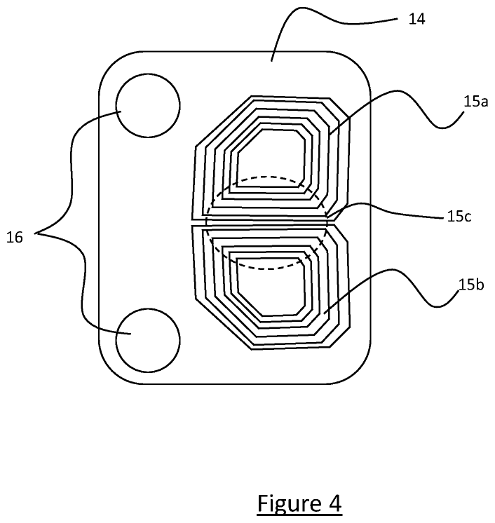

The stator 14 may be formed on a PCB and can be connected to the support by any suitable means, for example a pair of fasteners 13 as shown in FIG. 3. The PCB stator 14 is shown in isolation in FIG. 4 and it may be noted that the PCB may be provided with apertures 16 for receiving fasteners 13. A coil 15 is printed on the PCB stator 14 and as shown in the example may include a pair 15a, 15b of back-to-back loops each having a plurality of spiraled wires. For simplicity the loops 15a, 15b are shown in FIG. 4 as simple concentric shapes but it will be appreciated that they would be interconnected in practical examples such that current may flow through the coil. For example, the generally concentric shapes may be an interconnected spiral of shapes. The central area 15c of the coil 15 may provide a relatively large number of generally parallel wires. The parallel wires in the central area 15c may be generally aligned to the radial direction of the apparatus (for example they are substantially radial with respect to the axis of the deflector member). The wires in the central region 15c may be the electro-magnetically active part which may interact with the permanent magnets 22 (described further below) in the operation of the linear contactless motor.

Each motor 10 may further comprise a rotor 20 which is fixed relative to the deflector 4. The rotor 20 may carry at least one permanent magnet 22 to interact with the coils 15 of the stator 14. In the illustrated example the body of the rotor 20 has a generally U-shaped profile. The base 24 of the body may provide an attachment surface for connecting the rotor 20 to the deflector 4, for example by bonding with an adhesive. The arms 25 of the U-shaped member may extend in a generally radial direction away from the deflector 4 and may be parallel and spaced apart from one another. A permanent magnet 22 may be provided at a distal end of each arm 25. The magnets 22 may be spaced apart by the arms 25 such that they are opposed with a slot formed therebetween which can receive the stator 14. The stator 14 may be positioned between the two magnets 22 in a non-contact arrangement and may move within the magnetic field created in the gap. The portion of the stator 14 positioned in the gap between the magnets 22 may be the central area 15c of the PCB including the printed coils 15. As such, activation of current flow through the coils can be used to generate resulting relative movement of the rotor 20. As the wires in the central region 15c of the coils may extend generally parallel to the radial direction the movement induced interaction with the magnets of the rotor may be parallel to the radial direction (for example upward or downward as shown in the figures).

Whilst the main adjustment of the deflector 4 in the present disclosure may be rotation about its lengthwise axis, the examples may also provide additional functionality. For example, as the individual motors 10a, 10b, 10c and 10d may be linear motors they may be used to make other compensating adjustments. If a deflector 4 is found to be somewhat misaligned or curved along its length a vertical adjustment of the deflector could be made by operating the motors in a pair in the same linear direction. This could for example be used as a means of calibration and adjustment during set up of a print apparatus. Further it could be possible to make other dynamic adjustments such as vibrating the deflector in a vertical axis, for example vibration of the reflector could be used to counteract a vibration occurring in a print machine which may otherwise impact image quality.

Whilst the above described example relates to a generally 2D print press, the apparatus or imager of the disclosure may find use in other print apparatus. For example, an imager may be used in a 3D print apparatus in which the scanning beam from a light source may be used to selectively expose material on a bed of build material.

The preceding description has been presented to illustrate and describe examples of the principles described. This description is not intended to be exhaustive or to limit these principles to any precise form disclosed. Many modifications and variations are possible in light of the above teaching. It is to be understood that any feature described in relation to any one example may be used alone, or in combination with other features described, and may also be used in combination with any features of any other of the examples, or any combination of any other of the examples.

What is claimed is:

1. An apparatus comprising:
an elongate member including an optical element;
at least one bearing supporting the member to allow rotation about a lengthwise axis of the member; and
an actuator comprising a plurality of load sharing motors to apply torque to the member at a plurality of locations, the locations being spaced apart along the length of the member.

2. An apparatus as claimed in claim 1, wherein the load sharing motors comprise a plurality of motor groups, each motor group being at one of said plurality of locations.

3. An apparatus as claimed in claim 2, wherein each motor group comprises a motor pair, said motor pairs each comprising a first and second motor positioned at a common lengthwise location on said member.

4. An apparatus as claimed in claim 3, wherein the first and second motors of said motor pairs are radially opposed.

5. An apparatus as claimed in claim 4, wherein each motor comprises a contactless linear motor.

6. An apparatus as claimed in claim 5, wherein the contactless linear motors operate in opposing pairs to provide a torque about the member.

7. An apparatus as claimed in claim 1, wherein each motor comprises a printed circuit board comprising a coil and a magnetic element.

8. An apparatus as claimed in claim 7, wherein the printed circuit board is a stator and the magnetic element is a rotor movable by the coil of the printed circuit board.

9. An apparatus as claimed in claim 6, wherein the rotor comprises a pair of spaced apart magnetic elements and the stator is disposed between the magnetic elements.

10. An apparatus as claimed in claim 6, wherein the rotor is fixed to the member.

11. An apparatus as claimed in claim 1, wherein the bearing supporting the member is provided at an end of the elongate member.

12. An apparatus as claimed in claim 1, wherein the apparatus is an imager and the optical element is a deflector.

13. An apparatus as claimed in claim 10, wherein the imager comprises an optical image source and a photosensitive surface and wherein the deflector receives light from the image source and directs the light onto the photosensitive surface.

14. An apparatus as claimed in claim 11, wherein the apparatus comprises a drum including the photosensitive surface.

15. An apparatus as claimed in claim 12, wherein the apparatus further comprises at least one developing unit associated with said drum and at least one transfer roller.

16. An apparatus as claimed in claim 11, wherein the optical image source comprises a scanning optical beam.

17. An apparatus as claimed in claim 1, further comprising a controller to control the actuator.

18. A print press comprising an imaging unit, said imaging unit having an image compensation apparatus comprising:
an elongate member including an optical element;
at least one bearing supporting the member to allow rotation about a lengthwise axis of the member; and
an actuator comprising a plurality of load sharing motors to apply torque to the member at a plurality of locations, the locations being spaced apart along the length of the member and
an actuator controller to position the elongate member.

19. An imager comprising:
a photosensitive surface;
a light source to provide at least one scanning light beam;
an elongate deflector between the surface and the light source and arranged to deflect the at least one scanning light beam; and
an actuator to rotate the deflector about a rotational axis extending along a length of the deflector; wherein the actuator comprises a plurality of motors distributed along the length of the deflector.
